(19) United States
(12) Patent Application Publication
(10) Pub. No.: US 2014/0155214 A1
(43) Pub. Date: Jun. 5, 2014

(54) LUBRICATING OIL SUPPLY APPARATUS

(71) Applicants: Hiromichi KIMURA, Okazaki-shi (JP); Tatsuo OBATA, Toyota-shi (JP); Shingo KATO, Toyota-shi (JP); Yuya AOKI, Toyota-shi (JP)

(72) Inventors: Hiromichi KIMURA, Okazaki-shi (JP); Tatsuo OBATA, Toyota-shi (JP); Shingo KATO, Toyota-shi (JP); Yuya AOKI, Toyota-shi (JP)

(73) Assignee: TOYOTA JIDOSHA KABUSHIKI KAISHA, Toyota-shi (JP)

(21) Appl. No.: 14/094,984

(22) Filed: Dec. 3, 2013

(30) Foreign Application Priority Data
Dec. 5, 2012 (JP) 2012-266309

(51) Int. Cl. F16H 57/04

(52) U.S. Cl. CPC F16H 57/045
USPC 475/160

(57) ABSTRACT

A lubricating oil supply apparatus arranged in a transaxle case includes a differential ring gear, a catch tank that stores lubricating oil picked up by the differential ring gear, a first flow path arranged higher than a highest position of an outer diameter of the differential ring gear, a gear with a higher center position than the differential ring gear, and a second flow path that guides the lubricating oil picked up by the gear to the catch tank. The first flow path guides the lubricating oil picked up by the differential ring gear to the catch tank. The gear is in mesh with the differential ring gear, and picks up the lubricating oil picked up by the differential ring gear. The second flow path is arranged lower than a highest position of an outer diameter of the gear.

### INCORPORATION BY REFERENCE

The disclosure of Japanese Patent Application No. 2012-266309 filed on Dec. 5, 2012 including the specification, drawings and abstract is incorporated herein by reference in its entirety.

### BACKGROUND OF THE INVENTION

1. Field of the Invention

The invention relates to a lubricating oil supply apparatus that stores lubricating oil picked up by a differential ring gear, in a catch tank.

2. Description of Related Art Japanese Patent Application Publication No. 2010-242783 (JP 2010-242783 A), for example, describes one such known lubricating oil supply apparatus that includes a first guide passage that guides lubricating oil to a catch tank when a differential ring gear rotates at a high speed, and a second guide passage that guides lubricating oil to the catch tank when the differential ring gear rotates at a low speed. When the differential ring gear rotates at a low speed, the lubricating oil is picked up by the differential ring gear and transferred to another gear such as a counter drive gear or a counter driven gear, and then led to the second guide passage by being picked up by this other gear.

### SUMMARY OF THE INVENTION

With the lubricating oil supply apparatus described in JP 2010-242783 A, the second guide passage is provided in a position higher than an outer diameter of the gear, so when the differential ring gear rotates at an extremely low speed, the lubricating oil has difficulty being led to the second guide passage against gravity.

Therefore, when the differential ring gear is rotating at an extremely low speed, not much lubricating oil is carried to and stored in the catch tank, so much of the lubricating oil ends up being held at a lower portion of the differential ring gear. As a result, there is a large amount of lubricating oil agitating resistance from the differential ring gear, so power loss may occur.

The invention thus provides a lubricating oil supply apparatus capable of reducing power loss due to lubricating oil agitating resistance, even when a differential ring gear rotates at an extremely low speed.

One aspect of the invention relates to a lubricating oil supply apparatus that includes a transaxle case, a differential ring gear, a tank, and a gear. The transaxle case houses a gear mechanism and lubricating oil. The transaxle case has a first flow path and a second flow path inside the transaxle case. The differential ring gear is provided inside the transaxle case. The differential ring gear is configured to pick up the lubricating oil stored in a lubricating oil storage portion of a lower portion inside the transaxle case. The first flow path is arranged higher than a highest position of an outer diameter of the differential ring gear. The tank is provided inside the transaxle case. The tank is configured to store the lubricating, oil picked up by the differential ring gear. The first flow path guides the lubricating oil picked up by the differential ring gear to the tank. The gear is provided inside the transaxle case. A center position of the gear is higher than the differential ring gear. The gear is in mesh with the differential ring gear. The gear is configured to pick up the lubricating oil picked up by the differential ring gear. The second flow path guides the lubricating oil picked up by the gear to the tank. The second flow path is arranged lower than a highest position of an outer diameter of the gear.

According to this structure, even when the differential ring gear and the gear are rotating at an extremely low speed, the lubricating oil is able to be guided to the tank by the second guide flow path provided in a position lower than the highest position of the outer diameter of the gear. Therefore, lubricating oil is prevented from being held in the lubricating oil storage portion, so the oil level can be lowered. As a result, power loss due to lubricating oil agitating resistance is able to be reduced even when the differential ring gear is rotating at an extremely low speed.

In the lubricating oil supply apparatus described above, the tank may have a discharge hole, the discharge hole may discharge the lubricating oil from the tank to the lubricating oil storage portion, and the discharge hole may be arranged lower than the center position of the gear.

According to this structure, the drop in the lubricating oil that is discharged from the discharge hole and runs down into the lubricating oil storage portion is able to be reduced. As a result, the lubricating oil that runs down into the lubricating oil storage portion will not foam, so the lubricating oil agitating resistance of the differential ring gear due to an increase in the level of the lubricating oil as a result of foaming is able to be prevented, and the intake of air through a strainer is also able to be prevented.

The lubricating oil supply apparatus described above may also include a parking lock mechanism. This parking lock mechanism may be provided inside the transaxle case. The parking lock mechanism may be configured to be set to a locked state in which transmission of power from the gear mechanism is prevented, or an unlocked state in which the transmission of power from the gear mechanism is allowed. The discharge hole may be arranged separated from the parking lock mechanism in a horizontal direction.

According to this structure, the discharge hole is arranged horizontally apart from the parking lock mechanism and lower than the center position of the gear, so lubricating oil that is discharged from the discharge hole will not get on the parking lock mechanism. Therefore, a change in the friction force at the portions of the parking lock mechanism is able to be prevented, so a change in the operating force of the parking lock mechanism due to this change in friction force is also able to be prevented.

In the lubricating oil supply apparatus described above, at least a portion of the tank may be arranged in a vehicle front side end portion inside the transaxle case.

According to this structure, the lubricating oil inside the tank is able to be cooled by wind generated when the vehicle runs.

In the lubricating oil supply apparatus described above, the transaxle case may have a communication hole, the communication hole may communicate the tank with a portion of the gear mechanism, and the communication hole may be arranged lower than the second flow path.

According to this structure, lubricating oil is able to be supplied from the tank to a portion of the gear mechanism through the communication hole, so a portion of the gear mechanism is able to be well lubricated even when a pump that draws up lubricating oil from the lubricating oil storage portion is not operating.

According to the invention, a lubricating oil supply apparatus capable of reducing power loss due to lubricating oil agitating resistance even when a differential ring gear is rotating at an extremely low speed is able to be provided.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a block diagram of a drive apparatus provided with a lubricating oil supply structure according to one example embodiment of the invention, with a meshing portion of a drive pinion and a differential ring gear shown in the lower part of the drawing;

FIG. 2 is a partial sectional view of a parking brake mechanism of the drive apparatus provided with the lubricating oil supply structure according to the example embodiment of the invention, when viewed in an extending direction of a hollow shaft inside of a transaxle case;

FIG. 3 is a sectional view of the parking brake mechanism of the drive apparatus provided with the lubricating oil supply structure according to the example embodiment of the invention, when viewed from inside the transaxle case toward the outside;

FIG. 4 is a side view of a housing of the drive apparatus provided with the lubricating oil supply structure according to the example embodiment of the invention, when viewed from an open portion on a casing side;

FIG. 5 is a side view of a casing of the drive apparatus provided with the lubricating oil supply structure according to the example embodiment of the invention, when viewed from an open portion on a housing side;

FIG. 6 is a side view of the housing of the drive apparatus provided with the lubricating oil supply structure according to the example embodiment of the invention, when viewed from an open portion on the casing side, which shows a path of lubricating oil when the drive apparatus is operating at a low speed;

FIG. 7 is a side view of the housing of the drive apparatus provided with the lubricating oil supply structure according to the example embodiment of the invention, when viewed from an open portion on the casing side, which shows a path of lubricating oil when the drive apparatus is operating at a high speed;

FIG. 8 is an enlarged view of the housing of the drive apparatus provided with the lubricating oil supply structure according to the example embodiment of the invention, which shows a state in which lubricating oil is flowing out from a third catch tank; and

FIG. 9 is a is a sectional view of a cross-section passing through a ball bearing and a second catch tank of the drive apparatus provided with the lubricating oil supply structure according to the example embodiment of the invention, which shows a path of the lubricating oil from the second catch tank to the ball bearing.

### DETAILED DESCRIPTION OF EMBODIMENTS

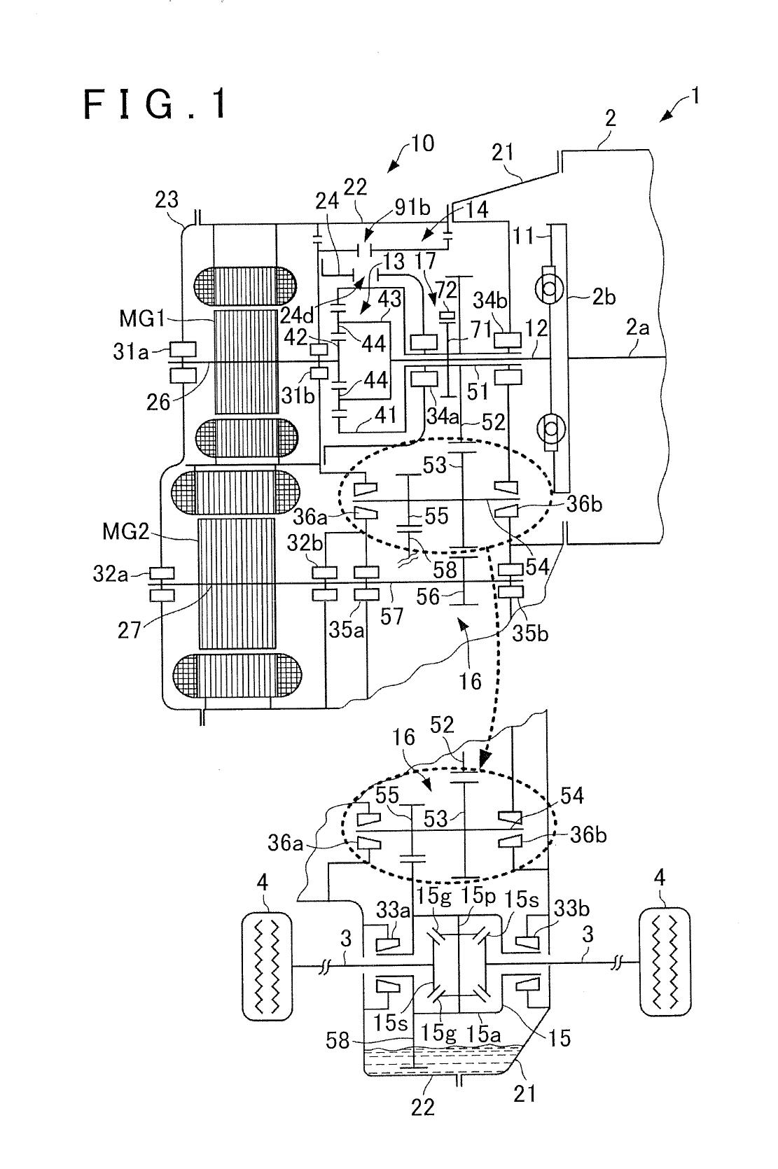

Hereinafter, example embodiments of the invention will be described with reference to the accompanying drawings. FIGS. 1 to 9 are views of a lubricating oil supply apparatus (lubricating oil supply structure) according to one example embodiment of the invention. FIG. 1 is a view of the structure of a drive apparatus provided with the lubricating oil supply apparatus according to this example embodiment of the invention.

As shown in FIG. 1, a drive apparatus 10 is configured as a transaxle of a hybrid vehicle 1 that is driven by one or both of an engine that is driven by fuel and a motor-generator as a rotary electric machine.

The vehicle 1 is a Front engine Front drive (FF) vehicle, and includes an engine 2 as an internal combustion engine, the drive apparatus 10, left and right drive shafts 3 that are connected to the drive apparatus 10, left and right wheels 4 that are connected to the left and right drive shafts 3, and an electronic control unit (ECU), not shown, that controls the engine 2 and the drive apparatus 10.

This electronic control unit includes a CPU (Central Processing Unit), ROM within which processing programs and the like are stored, RAM within which data is temporarily stored, EEPROM that is made up of electrically re-writable nonvolatile memory, and an input port and an output port that include an A/D converter and a buffer and the like.

The drive apparatus according to the invention is not limited to this kind of transaxle for a hybrid. That is, the drive apparatus may also be a transaxle mounted in a so-called electric vehicle driven by an electric motor as a rotary electric machine, or a transaxle mounted in a fuel cell vehicle provided with an engine that is driven by fuel.

The drive apparatus 10 includes a transaxle damper 11 that is connected to a flywheel 2b of a crankshaft 2a that serves as a drive shaft of the engine 2, and that absorbs torque fluctuations of the crankshaft 2a, and an input shaft 12 that serves as a connecting shaft that is connected at one end to the transaxle damper 11 and into which power from the engine 2 is input.

Also, the drive apparatus 10 includes a planetary gear set 13 that is connected to the other end of the input shaft 12, a motor-generator MG1 that serves as a first rotary electric machine that is connected to the planetary gear set 13 and mainly charges a battery and supplies driving power, and a motor-generator MG2 that serves as a second rotary electric machine that mainly outputs power.

The drive apparatus 10 also includes a differential 15 that serves as an output shaft that outputs power transmitted from the engine 2 and the motor-generators MG1 and MG2, and a gear mechanism 16 that is formed by a plurality of gears and shafts to transmit power between the engine 2 and the motor-generator MG1, and the differential 15, as well as between the motor-generator MG2 and the differential 15.

Also, the drive apparatus 10 includes a housing 21, a casing 22, and a rear cover 23 that together form a transaxle case 20 within which are housed the planetary gear set 13, the motor-generators MG1 and MG2, the differential 15, the gear mechanism 16, and a parking lock mechanism 17.

Further, the drive apparatus 10 includes a parking lock mechanism 17 that is able to be placed in a locked state in which power is prevented from being transmitted from the gear mechanism 16 and an unlocked state in which power is allowed to be transmitted from the gear mechanism 16, and a planetary gear set, housing case 24 that is attached to the casing 22 and houses the planetary gear set 13.

Moreover, the drive apparatus 10 includes ball bearings 31a and 31b that support the motor-generator MG1, ball bearings 32a and 32b that support the motor-generator MG2, tapered roller bearings 33a and 33b that support the differential 15, and ball bearings 34a, 34b, 35a, and 35b and tapered roller bearings 36a and 36b that support the gear mechanism 16.

As shown in FIG. 1, the planetary gear set 13 includes a ring gear 41 that is connected to the gear mechanism 16, a sun gear 42 that is arranged with its axis aligned with the axis of ring gear 41, inside this ring gear 41, a carrier 43 that is inserted, with its axis aligned with the axes of the ring gear 41 and the sun gear 42, between the ring gear 41 and the sun gear 42, and that is connected to the input shaft 12, and pinion gears 44 that are rotatably supported by this carrier 43 and are in mesh with the ring gear 41 and the sun gear 42.

This carrier 43 is connected to the crankshaft 2a via the input shaft 12 and the transaxle damper 11, such that power output from the engine 2 is input to the carrier 43. Also, the sun gear 42 is connected to the motor-generator MG1. This planetary gear set 13 forms a so-called power split device that splits the power from the engine 2 between the motor-generator MG1 and the gear mechanism 16 (other than the bearing and shaft of the motor-generator MG1).

The motor-generator MG1 functions both as an electric motor for driving the vehicle 1, and a generator for charging the battery, and is controlled by an electronic control unit to mainly charge the battery or supply power for driving. The motor-generator MG1 includes a stator and a rotor.

This stator has a core that is fixed to an inner peripheral portion of the casing 22. A winding is wound around an outer periphery of this core so as to become a three-phase winding in order to generate a magnetic field. Also, the rotor has a MG1 rotor shaft 26, and permanent magnets made up of N poles and S poles provided around the MG1 rotor shaft 26.

The MG1 rotor shaft 26 is rotatably supported by the ball bearing 31a that is supported on the rear cover 23, and the ball bearing 31b that is supported on the casing 22. Also, the MG1 rotor shaft 26 is connected at one end portion to the sun gear 42 of the planetary gear set 13, and rotates together with the sun gear 42.

According to this structure, when three-phase alternating current (AC) flows through the three-phase winding of the stator based on a command from the electronic control unit, a rotating magnetic field is generated inside the motor-generator MG1. This rotating magnetic field is controlled to match the rotation speed and position of the rotor. The permanent magnets arranged in the rotor are attracted to the rotating magnetic field, and as a result, torque is generated. The amount of torque that is generated is controlled by the current, and the rotation speed is controlled by the frequency of an alternating current (AC) power supply.

Furthermore, this motor-generator MG1 is connected to an inverter, not shown, and is switched by the electronic control unit, between being an electric motor and a generator via a switching element that forms the inverter; so as to function as either an electric motor or a generator.

The motor-generator MG2 has the same structure and functions as the motor-generator MG1, and is controlled by the electronic control unit as mainly a power supply that outputs power. The motor-generator MG2 includes a stator and a rotor.

Similar to the motor-generator MG1, this stator has a core that is fixed to an inner peripheral portion of the casing 22, and a winding is wound around an outer periphery of this core so as to become a three-phase winding in order to generate a magnetic field. Also, the rotor has a MG2 rotor shaft 27, and permanent magnets made up of N poles and S poles provided around the MG2 rotor shaft 27.

The MG2 rotor shaft 27 is rotatably supported by the ball bearing 32a that is supported on the rear cover 23, and the ball bearing 32b that is supported on the casing 22. Also, the MG2 rotor shaft 27 is connected at one end portion to the gear mechanism 16, and outputs power to the gear mechanism 16.

Also, similar to the motor-generator MG1, the motor-generator MG2 is connected to an inverter, not shown, and is switched by the electronic control unit, between being an electric motor and a generator via the inverter including a switching element, so as to function as either an electric motor or a generator.

The differential 15 includes a hollow differential case 15a. This differential case 15a is rotatably supported by the tapered roller bearing 33a provided on the casing 22, and the tapered roller bearing 33b provided on the housing 21.

A pinion shaft 15p is supported in the differential case 15a. A pair of pinion gears 15g are rotatably supported on this pinion shaft 15p. This pair of pinion gears 15g are in mesh with a pair of side gears 15s.

Also, the left and right drive shafts 3 are connected to the side gears 15s. Power from the gear mechanism 16 is input to the side gears 15s, and then output to the left and right wheels 4 via the left and right drive shafts 3. This differential 15 allows for a difference in rotation between the left and right wheels 4 that occurs when cornering and when the vehicle 1 changes direction.

The gear mechanism 16 includes a hollow shaft 51 that is connected to the ring gear 41 of the planetary gear set 13 and through which the input shaft 12 inserted, a counter drive gear 52 that is supported on the hollow shaft 51, a counter driven gear 53 that is in mesh with the counter drive gear 52, a counter shaft 54 that supports the counter driven gear 53, and a drive pinion 55 that is supported on the counter shaft 54.

The gear mechanism 16 also includes a reduction gear 56 that is in mesh with the counter driven gear 53, a reduction shaft 57 that is connected to the MG2 rotor shaft 27 of the motor-generator MG2 and supports the reduction gear 56, and a differential ring gear 58 that is in mesh with the drive pinion 55 and is fixed to the differential case 15a of the differential 15.

In this example embodiment, the center position of the counter drive gear 52 is arranged in a position that is higher than the center position of the differential ring gear 58, so the counter drive gear 52 picks up the lubricating oil that the differential ring gear 58 picked up from a lubricating oil storage portion 84, which will be described later.

The hollow shaft 51 is rotatably supported by the ball bearing 34a provided on the casing 22, and the ball bearing 34b provided on the housing 21.

The counter shaft 54 is rotatably supported by the tapered roller bearing 36a provided on the casing 22, and the tapered roller bearing 36b provided on the housing 21.

The reduction shaft 57 is rotatably supported by the ball bearing 35a provided on the casing 22, and the ball bearing 35b provided on the housing 21.

The reduction gear 56 that is in mesh with the counter driven gear 53, and the differential ring gear 58 that is in mesh with the drive pinion 55 provide a deceleration function that decelerates the rotation of the motor-generator MG2.

Also, as the differential ring gear 58 rotates, it picks up lubricating oil stored in the lubricating oil storage portion 84 of a lower portion inside the transaxle case 20 that is formed by the housing 21, the casing 22, and the rear cover 23, and carries it to an upper portion inside the transaxle case 20.

Then the lubricating oil that has been picked up by the differential ring gear 58 lubricates lubrication elements such as the planetary gear set 13, the gear mechanism 16, and the ball bearings 31a and 31b and the tapered roller bearings 33a and 33b and the like, which form the drive apparatus 10.

The housing 21 is molded with an aluminum die-cast mold or the like, and is highly rigid due to an arrangement of a plurality of ribs, not shown. As shown in FIG. 1, this housing 21 is fixed at one end portion to the engine 2 by fixing bolts, not shown, with the flywheel 2b and the transaxle damper 11 housed inside of the housing 21.

Similar to the housing 21, the casing 22 is also molded with an aluminum die-cast mold or the like, and is highly rigid due to an arrangement of a plurality of ribs, not shown.

The parking lock mechanism 17 forms a so-called shift-by-wire type shift control system that detects, by way of a sensor or a switch, a shift operation input by a driver of the vehicle 1, and selects a shift position according to the detected signal.

This parking lock mechanism 17 switches between shift positions that include a parking position and a non-parking position that is a position other than the parking position.

The parking lock mechanism 17 is configured such that when a parking switch provided on a driver's seat of the vehicle 1 is turned on, the parking lock mechanism 17 switches to the parking position, and the hollow shaft 51 of the gear mechanism 16 becomes locked, such that the vehicle 1 is maintained in a stopped state.

Also, when the parking switch is turned off, the parking lock mechanism 17 switches to the non-parking position, and the hollow shaft 51 of the gear mechanism 16 becomes unlocked, such that the vehicle 1 is able to be driven (run).

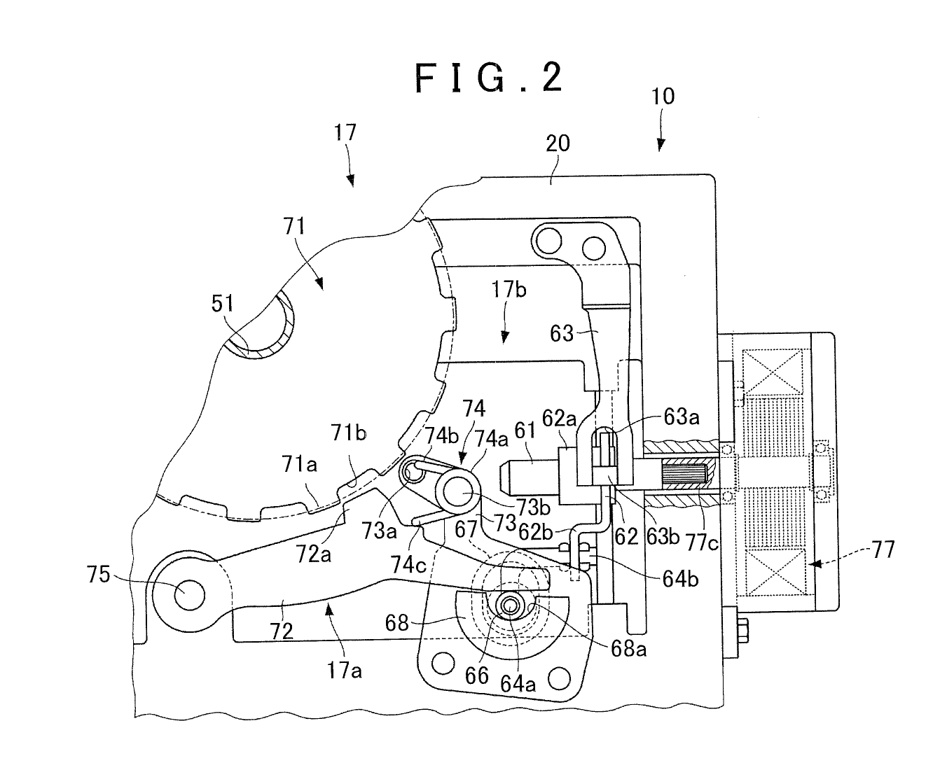

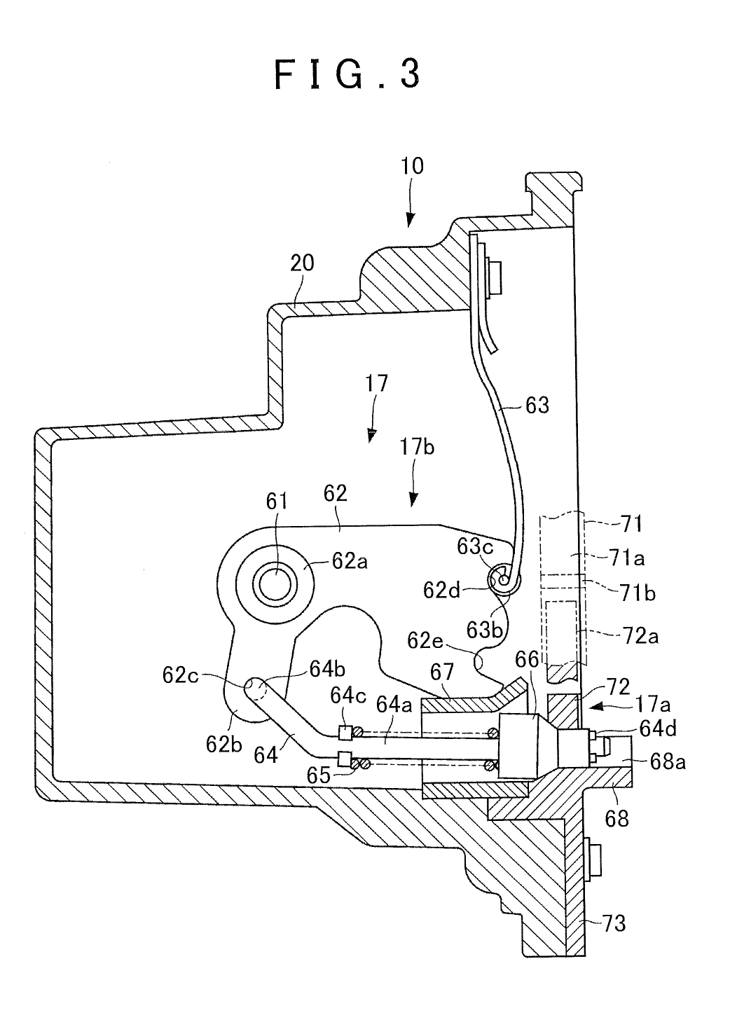

As shown in FIGS. 2 and 3, the parking lock mechanism 17 includes parking lock portion 17a, a lock mechanism portion 17b, and a motor 77. The parking lock portion 17a and the lock mechanism portion 17b are provided inside of the transaxle case 20, and are driven by the motor 77 that is provided on the outside of the transaxle case 20.

The parking lock portion 17a includes a parking gear 71, a parking lock pawl 72, a bracket 73, and a torsion spring 74.

The parking gear 71 is attached to the hollow shaft 51 arranged inside of the transaxle case 20, and is able to rotate together with the hollow shaft 51. Teeth 71a are formed at equidistant intervals on an outer edge portion of this parking gear 71, and the space between adjacent teeth 71a is an inter-tooth valley portion 71b that is recessed toward the center of the parking gear 71.

The parking lock pawl 72 is arranged in a position below the parking gear 71. A base end portion of this parking lock pawl 72 is pivotally supported on the transaxle case 20 by a pin 75.

An axis of the pin 75 extends parallel to a rotation central axis of the hollow shaft 51 of the drive apparatus 10, and when the parking lock pawl 72 pivots centered around the pin 75, a longitudinally intermediate portion of the parking lock pawl 72 becomes closer to or farther away from the outer edge portion of the parking gear 71.

Moreover, a protruding portion 72a that is able to fit into and engage with the inter-tooth valley portion 71b of the parking gear 71 is formed on an upper surface of the longitudinally intermediate portion of the parking lock pawl 72.

The bracket 73 is attached to the transaxle case 20. A hole 73a that extends in the plane thickness direction is formed in this bracket 73. Also, a supporting protrusion 73b that extends parallel to the pin 75 is provided on the bracket 73.

The torsion spring 74 has a coil portion 74a formed in a spiral shape, one arm 74b that protrudes from a winding start end of the coil portion 74a, and another arm 74c that protrudes from a winding terminal end of the coil portion 74a.

The coil portion 74a of the torsion spring 74 surrounds the supporting protrusion 73b of the bracket 73 in the circumferential direction. The one arm 74b is engaged with the hole 73a of the bracket 73, and the other arm 74c abuts against an edge portion of the parking lock pawl 72 that faces the parking gear 71.

The parking lock pawl 72 is urged in a direction in which the protruding portion 72a moves away from the outer edge portion of the parking lock pawl 72, by the restoring force of the torsion spring 74.

A DC motor that includes permanent magnets or electromagnets, or an SR motor (Switched Reluctance Motor), is used for the motor 77.

A rotor shaft 77c of the motor 77 is inserted into a hole, not shown, formed in a wall portion of the transaxle case 20. The axis of this hole forms a right angle to the axis of the hollow shaft 51, and the axis of the hole and the axis of the hollow shaft 51 have a so-called twisted positional relationship in which they do not exist on the same plane. Also, the motor 77 is fixed to the transaxle case 20 while the rotor shaft 77c is inserted in the hole.

The lock mechanism portion 17b includes a control rod 61, a detent plate 62 a detent spring 63, a parking rod 64, a compression spring 65, a parking cam 66, a cam holder 67, and a cam guide 68.

One end portion of the control rod 61 is inserted into a hole in the transaxle case 20. The one end portion of the control rod 61 is spline-engaged with the rotor shaft 77c of the motor 77, such that when the motor 77 is operated, the control rod 61 pivots together with the rotor shaft 77c.

The detent plate 62 has a boss portion 62a that protrudes in the plate thickness direction on one end portion.

A lever 62b that protrudes outward with the boss portion 62a as the center is formed on the one end portion of the detent plate 62. The lever 62b is bent in a general Z-shape when viewed front the extending direction of the hollow shaft 51. A hole 62c is formed extending through the lever 62b in the plate thickness direction.

Recessed portions 62d and 62e on two arcs that are recessed toward the one end portion of the detent plate 62 from the outer edge portion of the detent plate 62 are formed apart from one another on the other end portion of the detent plate 62.

The control rod 61 is inserted through the boss portion 62a, and the boss portion 62a is fixed to a longitudinally intermediate portion of the control rod 61. When the control rod 61 is rotated by the motor 77, the detent plate 62 rocks according to the movement of the control rod 61.

The detent spring 63 is a plate spring, and a notched portion 63a is formed on one end portion thereof. A roller 63b that extends parallel to the control rod 61 is arranged in this notched portion 63a. The roller 63b is rotatably supported at one end portion of the detent spring 63 by a pin 63c that extends parallel to the control rod 61.

The other end portion of the detent spring 63 is fixed to the transaxle case 20, such that the detent spring 63 rotatably pushes the roller 63b against the outer edge portion of the other end portion of the detent plate 62.

As a result, when the detent plate 62 rocks, the position of the detent plate 62 is set to an unlocked state in which the roller 63b is engaged with the recessed portion 62d, or a locked state in which the roller 63b is engaged with the recessed portion 62e.

The parking rod 64 is formed by a rod-like member, and has a supporting portion 64a that is able to rotate substantially parallel with respect to the axis of the hollow shaft 51 inside the drive apparatus 10, a connecting portion 64b that is continuous with the supporting portion 64a and extends at an angle with respect to the supporting portion 64a and that is connected to the lever 62b of the detent plate 62, a spring seat portion 64c that supports the compression spring 65, and a retaining portion 64d.

The connecting portion 64b is inserted into the hole 62c in the lever 62b of the detent plate 62, and is rotatably connected to the lever 62b. When the detent plate 62 rocks, the supporting portion 64a of the parking rod 64 is pushed and pulled in the axial direction.

The spring seat portion 64c is, formed protruding orthogonal to the axial direction of the parking rod 64, on a longitudinally intermediate portion of the supporting portion 64a.

The retaining portion 64d is formed protruding orthogonal to the axial direction of the parking rod 64, on a tip end portion of the supporting portion 64a.

The supporting portion 64a of the parking rod 64 is inserted into the compression spring 65, and one end portion of the compression spring 65 abuts against the spring seat portion 64c of the parking rod 64.

The parking cam 66 has a large outer diameter portion, a small outer diameter portion, and a tapered portion that is positioned between the large outer diameter portion and the small outer diameter portion, and is concentrically connected to both of these. An outer peripheral surface of this parking cam 66 is formed so as to be able to abut against a lower surface of a tip end portion of the parking lock pawl 72.

Furthermore, a hole that extends in the axial direction of the parking cam 66 is formed through the parking cam 66. The supporting portion 64a of the parking rod 64 is inserted through this hole, and an end surface of the large outer diameter portion of the parking cam 66 abuts against the other end portion of the compression spring 65.

The compression spring 65 pushes the parking cam 66 against the lower surface of the tip end portion of the parking lock pawl 72, such that the end surface of the small outer diameter portion of the parking cam 66 is able to abut against the retaining portion 64d.

The cam holder 67 is a cylindrical body that the parking cam 66 is able to go in and out of, and is provided surrounding the supporting portion 64a of the parking rod 64 in the circumferential direction, inside the transaxle case 20.

The cam guide 68 is integrally provided on the bracket 73 of the parking lock portion 17a. A concave curved surface 68a that allows the outer peripheral surface of the parking cam 66 to slide in the axial direction is formed facing the tip end portion side of the parking lock pawl 72, on the cam guide 68.

That is, when the position of the detent plate 62 is set to the locked state, the large outer diameter portion of the parking cam 66 advances onto the concave curved surface 68a of the cam guide 68.

Then, the large outer diameter portion of the parking cam 66 pushes on the lower surface of the tip end portion of the parking lock pawl 72, such that the parking lock pawl 72 comes closer to the parking gear 71 against the restoring force of the torsion spring 74. As a result, the protruding portion 72a engages with the inter-tooth valley portion 71b, and the parking gear 71 consequently becomes locked.

Also, when the position of the detent plate 62 is set to the unlocked state, the large outer diameter portion of the parking cam 66 retracts from the concave curved surface 68a of the cam guide 68.

Then the large outer diameter portion of the parking cam 66 separates from the lower surface of the tip end portion of the parking lock pawl 72, and the parking lock pawl 72 moves away from the parking gear 71 by the restoring force of the torsion spring 74. As a result, the protruding portion 72a disengages from the inter-tooth valley portion 71b, such that the parking gear 71 unlocks.

Next, the operation of the parking lock mechanism 17 will be briefly described. In the parking lock mechanism 17, the control rod 61 of the lock mechanism portion 17b rotates when the motor 77 is operated.

The movement of the control rod 61 is transmitted to the parking rod 64 via the detent plate 62, such that the parking cam 66 that is attached to the parking rod 64 either pushes on the parking lock pawl 72, or stops pushing on the parking lock pawl 72.

When the parking lock pawl 72 is pushed on by the parking cam 66, protruding portion 72a of the parking lock pawl 72 engages with the inter-tooth valley portion 71b of the parking gear 71, such that the parking gear 71 becomes locked.

On the other hand, when the parking lock pawl 72 stops being pushed on by the parking cam 66, the protruding portion 72a of the parking lock pawl 72 disengages from the inter-tooth valley portion 71b of the parking gear 71 by the restoring force of the torsion spring 74, such that the parking gear 71 becomes unlocked.

Next, the lubricating oil supply apparatus inside the transaxle case 20 will be described. This lubricating oil supply apparatus may include the transaxle case.

The lubricating oil storage portion 84 that stores lubricating oil is provided on a portion that houses the differential case 15a, of the lower portion inside the transaxle case 20.

The lubricating oil stored in the lubricating oil storage portion 84 is picked up and carried to the upper portion in the transaxle case 20 by the rotation of the differential ring gear 58, and lubricates lubrication elements such as the planetary gear set 13, the gear mechanism 16, the ball bearings 31a and 31b, and the tapered roller bearings 33a and 33b and the like, that form the drive apparatus 10.

Also, the lubricating oil stored in the lubricating oil storage portion 84 is drawn up through a strainer 85 provided in the bottom portion inside the transaxle case 20 and fed by an oil pump, not shown, so as to cool some of the constituent elements of the drive apparatus 10, such as the stator of the motor-generator MG1, for example.

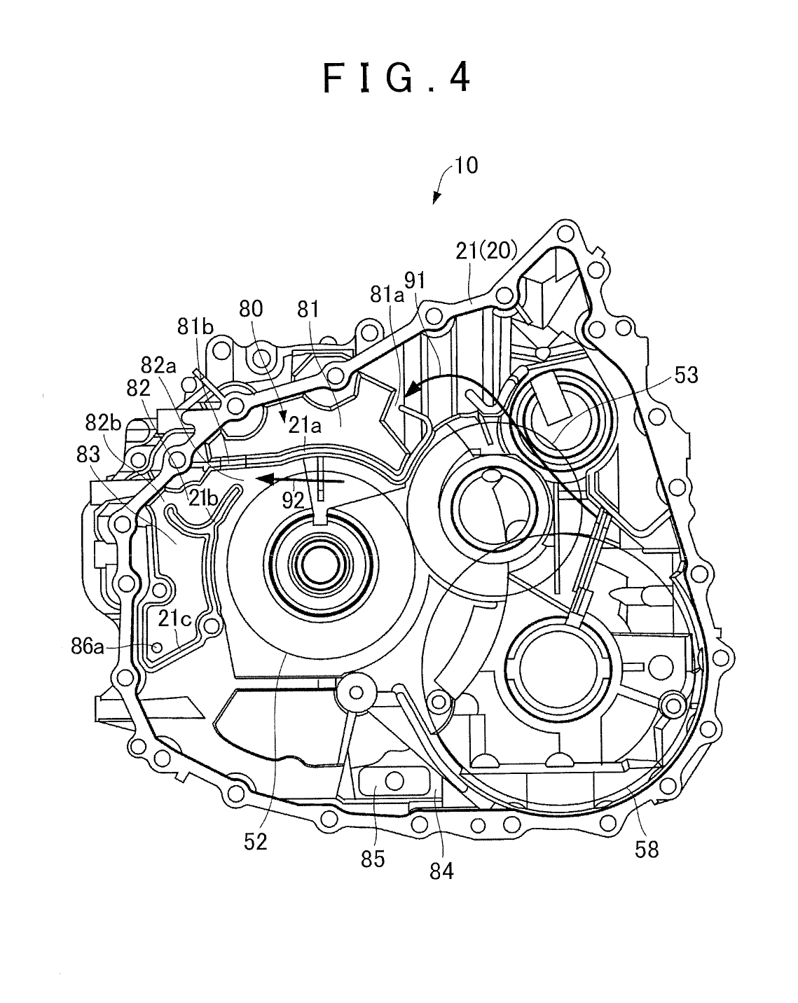

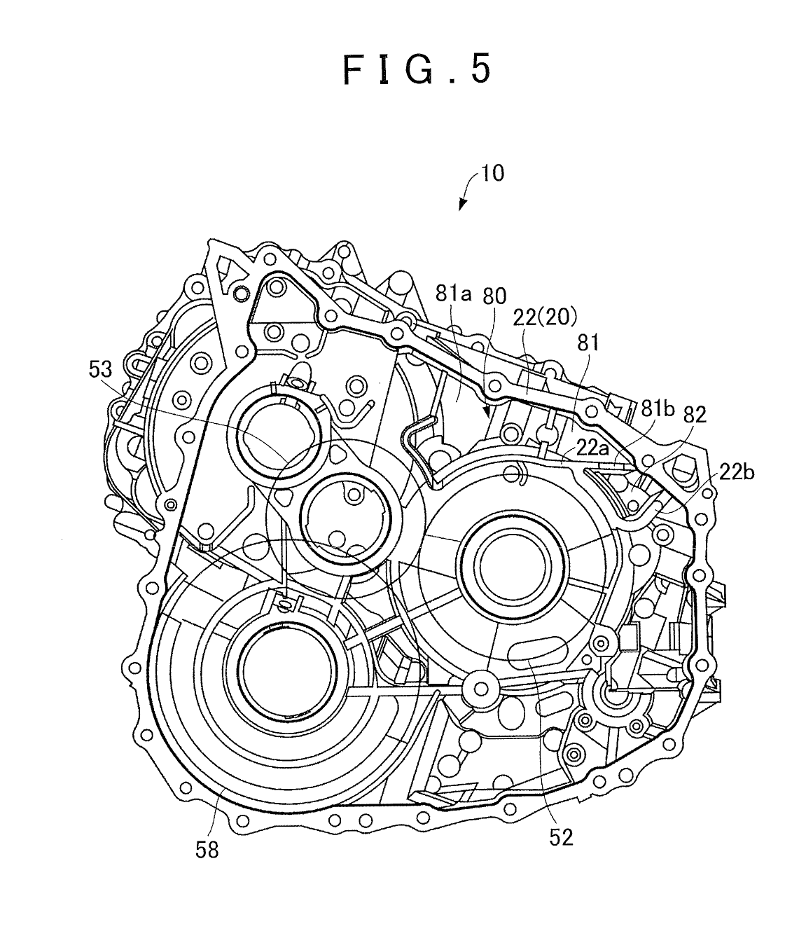

A catch tank 80 that stores the lubricating oil that the differential ring gear 58 has picked up from the lubricating oil storage portion 84 is formed in the housing 21 and the casing 22, as shown in FIGS. 4 and 5. The left side in FIG. 4 and the right side in FIG. 5 are toward the front of the vehicle. Also, the upper side in FIGS. 4 and 5 faces upward with respect to the vehicle.

The catch tank 80 is divided into a first catch tank 81, a second catch tank 82, and a third catch tank 83, and is formed by these catch tanks (i.e., the first catch tank 81, the second catch tank 82, and the third catch tank 83).

The first catch tank 81, the second catch tank 82, and the third catch tank 83 that make up the catch tank 80 are all arranged toward the front inside the transaxle case 20.

The first catch tank 81, the second catch tank 82, and the third catch tank 83 are communicated together. Of these, the first catch tank 81 is arranged in the highest portion. The second catch tank 82 is arranged lower than the first catch tank 81, and the third catch tank 83 is arranged lower than the second catch tank 82. Therefore, the lubricating oil flows down in order from the first catch tank 81, to the second catch tank 82, to the third catch tank 83.

In this example embodiment, the first catch tank 81 is arranged in an upper portion of the counter drive gear 52. Also, the second catch tank 82 is arranged on the upper left side of the counter drive gear 52 in FIG. 4.

Also, the third catch tank 83 is arranged on the left side of the counter drive gear 52 in FIG. 4. Therefore, the second catch tank 82 and the third catch tank 83 are arranged on the front side of the vehicle, inside the transaxle case 20.

Here, the left side in FIG. 4 is the front side of the vehicle, so the second catch tank 82 and the third catch tank 83 that are arranged on the front side of the vehicle inside the transaxle case 20 are able to better catch the wind as the vehicle 1 runs.

The first catch tank 81 and the second catch tank 82 are formed on both the housing 21 and the casing 22, and are thus defined by both the housing 21 and the casing 22. The third catch tank 83 is formed on the housing 21 side.

The first catch tank 81 is defined by a tank wall 21a formed in a strip protruding at a predetermined height from an inside wall of the housing 21 in this housing 21. Also, the first catch tank 81 is similarly defined by a tank wall 22a formed in a strip protruding at a predetermined height from an inside wall of the casing 22 in this casing 22.

These tank walls 21a and 22a that define the first catch tank 81 are formed in a position that becomes the upper portion of the counter drive gear 52. That is, the first catch tank 81 is formed in a position that becomes the upper portion of the counter drive gear 52.

The second catch tank 82 is defined by a tank wall 21b having a belt shape in this housing 21. The tank wall 21b protrudes at a predetermined height from the inside wall of the housing 21 in the housing 21. Also, the second catch tank 82 is similarly defined by a tank wall 22b having a belt shape in this casing 22. The tank wall 22b protrudes at a predetermined height from an inside wall of the casing 22 in the casing 22.

These tank walls 21b and 22b that define the second catch tank 82 are formed below the tank walls 21a and 22a that define the first catch tank 81. That is, the second catch tank 82 is arranged below the first catch tank 81.

The third catch tank 83 is defined by a tank wall 21c having a belt shape in this housing 21. The tank wall 21c protrudes at a predetermined height from the inside wall of the housing 21 in the housing 21. The tank wall 21c that defines the third catch tank 83 is formed below the tank walls 21b and 22b that define the second catch tank 82. That is, the third catch tank 83 is arranged below the second catch tank 82.

An inflow opening 81a through which lubricating oil that has been picked up by the differential ring gear 58 flows in is provided in an upper portion of the first catch tank 81. Also, an outflow opening 81b through which lubricating oil flows out is provided in the first catch tank 81 in a position lower than the inflow opening 81a.

The outflow opening 81b is provided above the second catch tank 82, such that lubricating oil that flows out from this outflow opening 81b flows into the second catch tank 82.

An inflow opening 82a through which lubricating oil that has been picked up by the counter drive gear 52 after being picked up by the differential ring gear 58 is provided in an upper portion of the second catch tank 82. Also, an outflow opening 82b through which lubricating oil the second catch tank 82 flows out is provided in a lower portion of the second catch tank 82.

That is, lubricating oil that flows out from the outflow opening 81b of the first catch tank 81 flows into the second catch tank 82, and lubricating oil that has been picked up by the counter drive gear 52 flows into the second catch tank 82 via the inflow opening 82a.

The third catch tank 83 has a discharge hole 86a that discharges lubricating oil that flows out from the second catch tank 82, provided in a side surface of a lower portion thereof. This discharge hole 86a is provided in a position lower than the center position of the counter drive gear 52.

Also, the discharge hole 86a is arranged away from the parking lock mechanism 17 in the horizontal direction. That is, the parking lock mechanism 17 is provided on the casing 22 side, while the discharge hole 86a is provided on the housing 21 side.

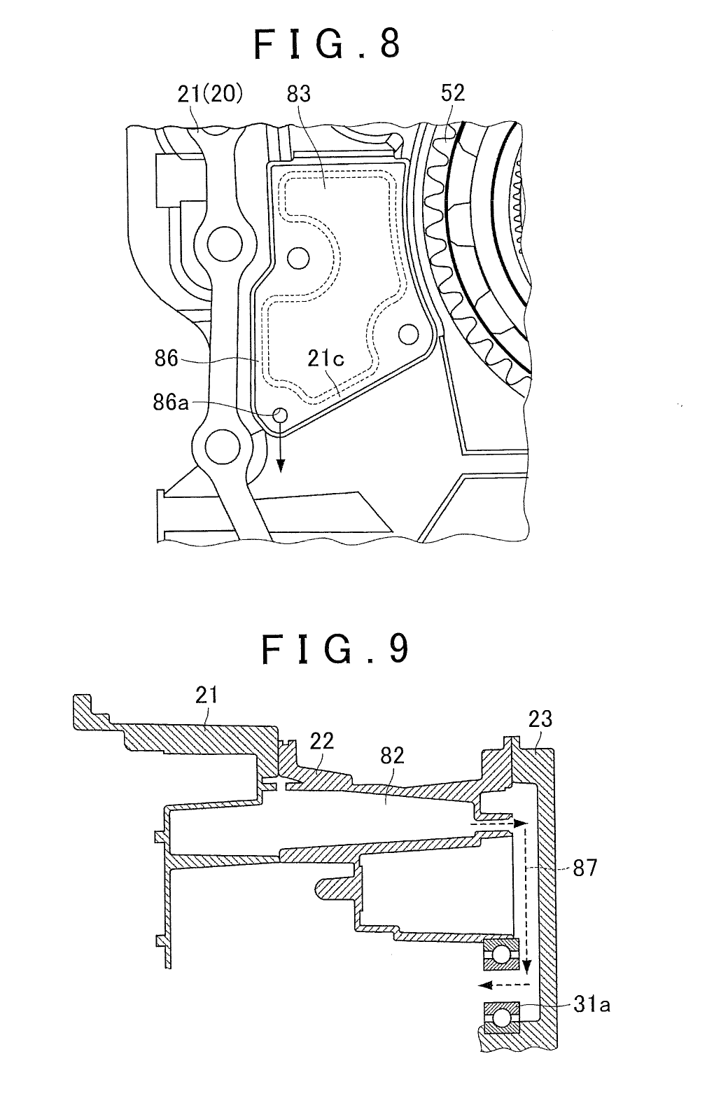

This discharge hole 86a is provided in a plate 86 that forms one side surface (i.e., the side surface on the front side in FIG. 8) of the third catch tank 83 in the housing 21, as shown in FIG. 8. The plate 86 is formed by a plate member, and is fixed to the housing 21 by being bolted thereto.

After being discharged in the horizontal direction from the discharge hole 86a, the lubricating oil flows downward by gravitational force and drips down into the lubricating oil storage portion 84.

In this example embodiment, of the lubricating oil passages that extend from an outer diameter right-side portion of the differential ring gear 58 to the inflow opening 81a of the first catch tank 81 in FIG. 4, the passage in a position higher than the highest position of the outer diameter of the differential ring gear 58 serves as a first guide flow path 91. This first guide flow path 91 is formed by a space between members such as the counter driven gear 53 above the differential ring gear 58.

Also, when the differential ring gear 58, the counter driven gear 53, and the counter drive gear 52 are rotating at a high speed, lubricating oil that has been picked up from the lubricating oil storage portion 84 by the rotation of the differential ring gear 58 is guided to the first guide flow path 91 so as to flow into the inflow opening 81a of the first catch tank 81.

Also, in FIG. 4, a space on the side surface-side higher than the center of the counter drive gear 52 serves as a second guide flow path 92 by which lubricating oil that has first been picked up by the differential ring gear 58 and then been picked up by the counter drive gear 52 is guided to the inflow opening 82a of the second catch tank 82. The second guide flow path 92 is arranged in a position lower than the highest position of the outer diameter of the counter drive gear 52.

Also, when the differential ring gear 58, the counter driven gear 53, and the counter drive gear 52 are rotating at an extremely low speed, lubricating oil that has been picked up from the lubricating oil storage portion 84 by the differential ring gear 58 and then the counter drive gear 52 is guided to the second guide flow path 92 so as to flow into the inflow opening 82a of the second catch tank 82.

Also, as shown in FIG. 9, a communication hole 87 that communicates the second catch tank 82 with the ball bearing 31a that is a portion of the gear mechanism 16, is formed on the rear cover 23 side of the second catch tank 82. This communication hole 87 is arranged in a position lower than the second guide flow path 92.

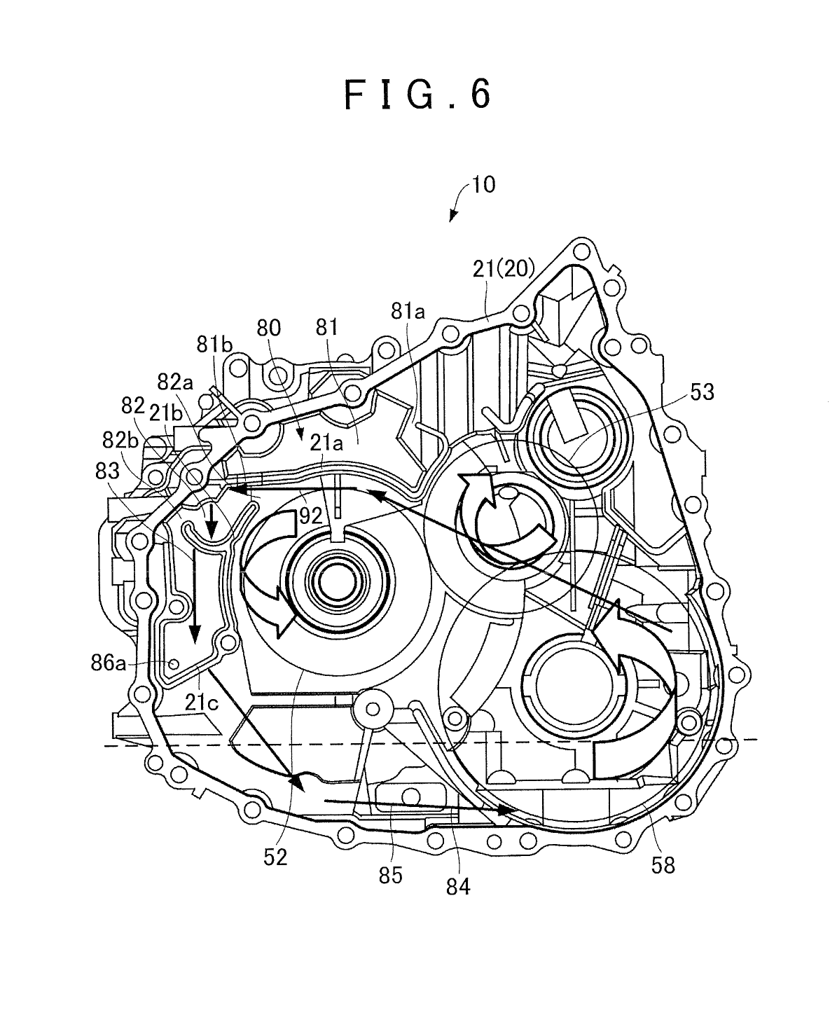

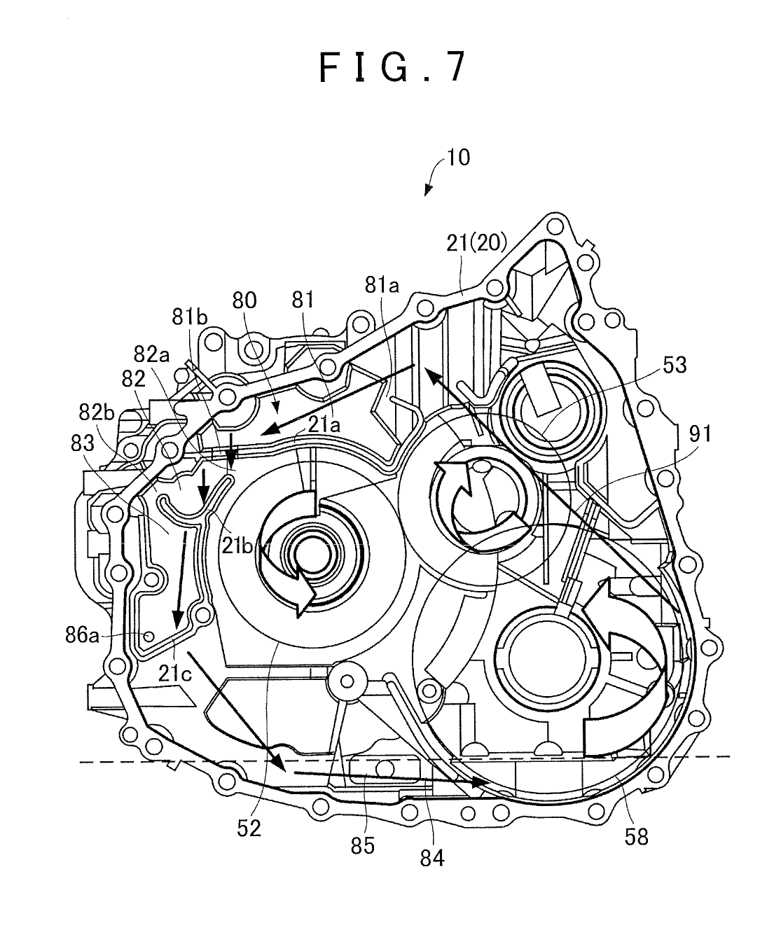

Next, the operation of the lubricating oil supply apparatus in the transaxle case 20 structured as described above will be described with reference to FIGS. 6 and 7.

When the vehicle 1 is running at a low speed or an extremely low speed, the differential ring gear 58, the counter driven gear 53, and the counter drive gear 52 that make up the gear mechanism 16 in the transaxle case 20 rotate at a low speed or an extremely low speed, and lubricating oil stored in the lubricating oil storage portion 84 is picked up by the differential ring gear 58, as shown in FIG. 6.

The lubricating oil that is picked up by the differential ring gear 58 is transferred to the counter drive gear 52, where it is picked up again and carried along the outer diameter on the upper side of the counter drive gear 52, after which it flows into the second catch tank 82. After moving from the second catch tank 82 to the positive electrode foil 32, the lubricating oil then returns to the lubricating oil storage portion 84.

More specifically, in FIG. 6, the lubricating oil stored in the lubricating oil storage portion 84 is first picked up from a lower region of the differential ring gear 58, to a right-side region of the differential ring gear 58, to an upper region of the differential ring gear 58 by the counterclockwise rotation of the differential ring gear 58, and then carried to a lower region of the counter driven gear 53.

Then the lubricating oil is picked up to the left-side region of the counter driven gear 53 and then carried to the upper right region of the counter drive gear 52, by the clockwise rotation of the counter driven gear 53. Then the lubricating oil is picked up again by the counterclockwise rotation of the counter drive gear 52, guided to the second guide flow path 92 that is the space from the upper right region of the counter drive gear 52 to the upper left region of the counter drive gear 52, and flows into the second catch tank 82 from the inflow opening 82a.

The lubricating oil that flows into the second catch tank 82 is supplied to the ball bearing 31a through the communication hole 87. Also, when the level of the lubricating oil that flows into the second catch tank 82 exceeds the outflow opening 82b, the lubricating oil flows out from this outflow opening 82b and into the third catch tank 83.

The lubricating oil that flows into the third catch tank 83 flows out from the discharge hole 86a provided in the plate 86 and flows down to the lubricating oil storage portion 84. The lubricating oil that flows out from the discharge hole 86a will not get on the parking lock mechanism 17 that is arranged away from the discharge hole 86a in the horizontal direction. Therefore, a change in the friction force at the portions of the parking lock mechanism 17 is able to be prevented, so a change in the operating force of the parking lock mechanism 17 due to this change in friction force is also able to be prevented.

Some examples of the portions of the parking lock mechanism 17 where the friction coefficient and friction force may change if lubricating oil were to get on them are sliding portions between the detent spring 63 and the detent plate 62, and sliding portions between the parking rod 64 and the parking lock pawl 72, in FIGS. 2 and 3.

In this way, when the vehicle 1 is running at a low speed or an extremely low speed, lubricating oil is able to be guided to the second catch tank 82 by the second guide flow path 92 provided in a position lower than the highest position of the outer diameter of the counter drive gear 52, so lubricating oil held in the lubricating oil storage portion 84 is able to be reduced, and thus the level of the lubricating oil in the lubricating oil storage portion 84 is lowered.

As a result, the lubricating oil agitating resistance from the differential ring gear 58 decreases, so power loss from the agitating resistance is able to be decreased.

On the other hand, when the vehicle 1 is running at a high speed, the differential ring gear 58, the counter driven gear 53, and the counter drive gear 52 that make up the gear mechanism 16 in the transaxle case 20 rotate at a high speed, so the lubricating oil stored in the lubricating oil storage portion 84 is swiftly picked up by the differential ring gear 58, as shown in FIG. 7.

The lubricating oil that is swiftly picked up by the differential ring gear 58 flows over the upper portion of the counter driven gear 53 and into the first catch tank 81, then moves from the first catch tank 81 to the third catch tank 83 via the second catch tank 82, and then returns to the lubricating oil storage portion 84.

More specifically, the lubricating oil stored in the lubricating oil storage portion 84 is first picked up from the lower region of the differential ring gear 58 to the right-side region of the differential ring gear 58, and then to the upper region of the differential ring gear 58 by the counterclockwise rotation of the differential ring gear 58, and then sprayed toward the upper left by centrifugal force, as shown in FIG. 7.

The lubricating oil sprayed from the differential ring gear 58 by centrifugal force flies over the upper portion of the counter driven gear 53, is guided by the first guide flow path 91 and flows into the first catch tank 81 through the inflow opening 81a.

When level of the lubricating oil that flows into the first catch tank 81 exceeds the outflow opening 81b of the first catch tank 81, the lubricating oil flows out from this outflow opening 81b and into the second catch tank 82.

The lubricating oil that flows into the second catch tank 82 is supplied to the ball bearing 31a through the communication hole 87. Also, when the level of the lubricating oil that flows into the second catch tank 82 exceeds the outflow opening 82b, the lubricating oil flows out from this outflow opening 82b and into the third catch tank 83. The lubricating oil that flows into the third catch tank 83 flows out from the discharge hole 86a provided in the plate 86, and runs down to the lubricating oil storage portion 84.

In this way, when the vehicle 1 is running at a high speed, lubricating oil is able to be guided to the first catch tank 81 by the first guide flow path 91 arranged higher than the highest position of the outer diameter of the differential ring gear 58, so lubricating oil held in the lubricating oil storage portion 84 is able to be reduced even more.

As described above, in this example embodiment, the counter drive gear 52 that picks up the lubricating oil that has been picked up by the differential ring gear 58 includes the first guide flow path 91 that is arranged with a higher center position than the differential ring gear 58, and guides lubricating oil picked up by this differential ring gear 58 to the catch tank 80 (i.e., the first catch tank 81), in a higher position than the highest position of the outer diameter of the differential ring gear 58, and the second guide flow path 92 that guides the lubricating oil picked up by the counter drive gear 52 to the catch tank 80 (i.e., the second catch tank 82). The second guide flow path 92 is provided in a position lower than the highest position of the outer diameter of the counter drive gear 52.

According to this structure, even when the differential ring gear 58 and the counter drive gear 52 are rotating at an extremely low speed, lubricating oil is able to be guided to the catch tank 80 by the second guide flow path 92 provided in a position that is lower than the highest position of the outer diameter of the counter drive gear 52. Therefore, lubricating oil is prevented from being held in the lubricating oil storage portion 84, so the oil level is able to be lowered.

As a result, power loss due to lubricating oil agitating resistance is able to be reduced even when the differential ring gear 58 is rotating at an extremely low speed. Also, in this example embodiment, the discharge hole 86a that discharges lubricating oil from the catch tank 80 (i.e., the third catch tank 83) into the lubricating oil storage portion 84 is provided in a position that is lower than the center position of the counter drive gear 52.

According to this structure, the drop in the lubricating oil that is discharged from the discharge hole 86a and runs down into the lubricating oil storage portion 84 is able to be reduced. As a result, the lubricating oil that runs down into the lubricating oil storage portion 84 will not foam, so the lubricating oil agitating resistance of the differential ring gear 58 due to an increase in the level of the lubricating oil as a result of foaming is able to be prevented, and the intake of air through the strainer 85 is also able to be prevented.

Further, in this example embodiment, the parking lock mechanism 17 that is able to be placed in a locked state that prevents the transmission of power from the gear mechanism 16 and an unlocked state that allows the transmission of power from the gear mechanism 16, is provided in the transaxle case 20, and the discharge hole 86a is arranged away from the parking lock mechanism 17 in the horizontal direction.

According to this structure, the discharge hole 86a is arranged horizontally apart from the parking lock mechanism 17 and lower than the center position of the counter drive gear 52, so lubricating oil that is discharged from the discharge hole 86a will not get on the parking lock mechanism 17. Therefore, a change in the friction force at the portions of the parking lock mechanism 17 is able to be prevented, so a change in the operating force of the parking lock mechanism 17 due to this change in friction force is also able to be prevented.

Also, in this example embodiment, the second catch tank 82 and the third catch tank 83 that are at least a portion of the catch tank 80 are arranged on the vehicle front side end portion in the transaxle case 20.

This structure enables the lubricating oil inside the catch tank 80 to be cooled by wind generated when the vehicle runs.

Also, in this example embodiment, the communication hole 87 that communicates the catch tank 80 (i.e., the second catch tank 82) with a portion of the gear mechanism 16 is provided in a position lower than the second guide flow path 92.

According to this structure, lubricating oil is able to be supplied from the catch tank 80 to a portion of the gear mechanism 16 through the communication hole 87, so a portion of the gear mechanism 16 is able to be well lubricated even when a pump that draws up lubricating oil from the lubricating oil storage portion 84 is not operating.

What is claimed is:

1. A lubricating oil supply apparatus comprising:
a transaxle case within which a gear mechanism and lubricating oil are housed, the transaxle case having a first flow path and a second flow path inside the transaxle case;
a differential ring gear provided inside the transaxle case, the differential ring gear being configured to pick up the lubricating oil stored in a lubricating oil storage portion of a lower portion inside the transaxle case, the first flow path being arranged higher than a highest position of an outer diameter of the differential ring gear;
a tank provided inside the transaxle case, the tank being configured to store the lubricating oil picked up by the differential ring gear, the first flow path guiding the lubricating oil picked up by the differential ring gear to the tank; and
a gear provided inside the transaxle case, a center position of the gear being higher than the differential ring gear, the gear being in mesh with the differential ring gear, the gear being configured to pick up the lubricating oil picked up by the differential ring gear, the second flow path guiding the lubricating oil picked up by the gear to the tank, the second flow path being arranged lower than a highest position of an outer diameter of the gear.

2. The lubricating oil supply apparatus according to claim 1, wherein
the tank has a discharge hole;
the discharge hole discharges the lubricating oil from the tank to the lubricating oil storage portion; and
the discharge hole is arranged lower than the center position of the gear.

3. The lubricating oil supply apparatus according to claim 2, further comprising:
a parking lock mechanism provided inside the transaxle case, the parking lock mechanism being configured to be set to a locked state in which transmission of power from the gear mechanism is prevented, or an unlocked state in which the transmission of power from the gear mechanism is allowed, wherein
the discharge hole is arranged separated from the parking lock mechanism in a horizontal direction.

4. The lubricating oil supply apparatus according to claim 1, wherein at least a portion of the tank is arranged in a vehicle front side end portion inside the transaxle case.

5. The lubricating oil supply apparatus according to claim 1, wherein
the transaxle case has a communication hole;
the communication hole communicates the tank with a portion of the gear mechanism; and
the communication hole is arranged lower than the second flow path.
